(19) United States
(12) Patent Application Publication
(10) Pub. No.: US 2012/0053266 A1
(43) Pub. Date: Mar. 1, 2012

(54) POLYMER ADDITIVE TO STRENGTHEN CONCRETE

(75) Inventor: James V. Hodson, Fruit Heights, UT (US)

(73) Assignee: Brilliant Coatings, Inc., Niagara Falls, NY (US)

(21) Appl. No.: 12/872,177

(22) Filed: Aug. 31, 2010

(51) Int. Cl. C08K 5/5419; C04B 24/26

(52) U.S. Cl. 524/5; 524/267

(57) ABSTRACT

This invention provides an additive for Portland Cement comprising acrylic monomers and copolymers, wetting agent, polypropylene glycol and silicone.

### FIELD OF THE INVENTION

This invention relates to a polymeric additive for cement that improves its compression and tensile strength.

### BACKGROUND OF THE INVENTION

Portland Cement is widely used for building construction and road construction. While a well-known and reliable material it has certain deficiencies, such as in strength and resistance to water. These deficiencies have been addressed by the utilization of polymers to improve these properties. The polymers may be coated onto the surface of cement or included in the cement mixture itself.

U.S. Pat. No. 6,916,505 to Raymond et al., U.S. Pat. No. 6,548,589 to Widmer et al., and U.S. Pat. No. 6,387,176 to Widmer et al. are typical of patents related to the utilization of polymers in concrete.

Further, an additive comprising an acrylic emulsion for reinforcing cement has been marketed by Hodson Laboratories has a composition of comprising a vinyl copolymer emulsion, and a vinyl acetate/acrylic copolymer of 1 port vinyl acetate and 3 parts acrylic.

There remains a need for a polymer additive for cement to improve the strength and water resistance of the cement.

### SUMMARY OF THE INVENTION

The invention provides a polymer additive for Portland Cement comprising acrylic monomers and copolymers, wetting agent, polypropylene glycol and silicone.

### DETAILED DESCRIPTION OF THE INVENTION

The additive of the invention has numerous advantages over prior materials for adding to a cement, such as Portland Cement. The invention material improves compression and tensile strength. The cohesive strength of the cement is also improved. Further the invention cement additive materials are stable at sub-freezing temperatures prior to use. The invention additive is relatively low in cost and easily mixed with the cement prior to utilization. The additive may be controlled such that the cement may be applied by both gunning and casting techniques. These and other advantages of the invention will be clear from the detailed description below.

In a preferred form of the invention the chemical additive composition of the invention consists of the following: acrylic monomers and copolymers modified with organic polypropylene glycols, wetting agents consisting of nonyl-octal-phenolic ethylene oxide condensates, blended with a silicone fluid and emulsified with propylene glycol component. The intended use for the composition is to modify Portland Cement concrete imparting the following characteristics: increased compressive strength over a conventional cement, increased tensile strength, and increased flexural strength. The durability of the cement composition is enhanced as water resistance is increased, thus preventing freeze-thaw-degradation from taking place.

The polymer cement additive of the invention may be utilized in both new construction and in mending or repairing older construction. It may be used in repairing bridge supports and roads; or in new construction of the structures. The cements formed with additive of the invention also may be used in gunning of cement to reinforce structures such as the roofs of mines and tunnels.

In forming the polymer additive of the invention, generally the acrylic monomers and copolymers comprise between 3 and 1 parts by weight of the polymer additive. The wetting agent comprises between 1 and 10 parts by weight of the polymer additive. The propylene glycol comprises between 2 and 3 parts by weight of the polymer additive. The silicone comprises between 2 and 3 parts by weight of the polymer additive.

The acrylic monomers may have any suitable molecular weight. A suitable molecular weight is between 79 and 200 as determined by the weight average method.

The acrylic copolymers may be any suitable acrylic copolymers. Typical of acrylic copolymers suitable for the invention are vinyl copolymers forming a vinyl/acrylic copolymer emulsion. A preferred copolymer is a vinyl acetate/acrylic copolymer in a ratio of 1 part by weight vinyl acetile to 3 parts acrylic because these ratios provide the best hydrophilic/hydrophobic balance.

The wetting agent utilized for the invention may be any suitable wetting agent that will aid in disbursing the ingredients. Typical of suitable wetting agents are non-ionic ethylene oxide condensates. A preferred wetting agent is a non-ionic ethylene oxide condensate that is preferred so that any undesired chemical reactions will not occur in the additive materix. Another preferred wetting agent is silicone fluid because silicone fluid acts as a defoaming agent thus allowing for the removal of most of the entrapped air in the cement mix design. This increases the physical properties such as: (1) compressive strength, (2) flexural strength, and (3) tensile strength. It is also preferred to use a combination of ethylene oxide condensate and silicone fluid for the same reasons as listed above for the individual materials. A most preferred embodiment is the use of n-octal-phenolic ethylene oxide condensates blended with silicone fluid and emulsified with the propylene glycol component because octyl-nonyl phenolic ethylene oxide condensate blended with silicone fluid and emulsified with propylene glycol provides improved freeze and thaw properties of the cement. Propylene glycol acts as a safe diluent and has the desired solubility factor to carry the silicone fluid and the wetting agent into the acrylic polymer/copolymer without phase separation. Another advantage of the use of the propylene glycol is that it lowers the freezing point of the invention cement additive and makes storage of the additive cheaper and easier.

The acrylic polymers and copolymers generally comprise any suitable amount of the additive that results in an improved Portland Cement. Generally, there are present in an amount of between 75 and 90 weight percent of the total polymer additive of the invention. This provides a high ratio of 75% to 90% is to ensure that the polymer additive will be present in sufficient percentage to provide for micro encapsulation of the cement and aggregate particles.

The silicone fluid may be present in any suitable amount in the additive. Generally, an amount of between one and three weight percent of the total cement polymer additive is suitable. The silicone fluid generally has a viscosity of between about 10 and 100 pps. A preferred range of viscosity is between 30 and 90 pps. The most preferred silicone fluid viscosity range is between 40 and 60 pps as this provides an improved reduction in oxygen from the cement as it has reduced air entrainment and, therefore, provides higher physical characteristics in terms of strength and also improves the cement's resistance to moisture.

The propylene glycol generally is present in between about 5 and 15 weight percent of the total weight of the additive of the invention. The propylene glycol is believed to aid in providing a low freeze point of the concrete.

The invention also provides a method of forming a strengthened Portland Cement comprising mixing 6 to 30 parts by weight Portland cement with between one to three parts by weight of the invention cement polymer additive. The cement polymer additive of the invention comprises acrylic monomers and copolymers, wetting agent, propylene glycol, and silicone.

Any type of Portland Cement may be utilized in invention. Portland cement generally comes in Type 1, Type 2 and Type 3 and the use of a different type is dependent on availability, commercial needs and type of transport, as Type III may be air transported. If not otherwise indicated herein, Portland Cement may be considered as Type II Portland Cement. Generally, polymer reinforced Portland cement, of the prior art, have a tensile strength of between 300 and 500 psi and a tensile strength of about 300-400 psi. Conventional Portland cements may have the flexural strength of between 1400 and 1800 psi. The flexural strength of the cements made utilizing the invention additive are about 2100 psi, whereas the typical polymer reinforced Portland cement has a flexural strength of between 1400 and 1800 psi. The compressive strength of an invention additive reinforced cement is about 8,500 psi to fracture. The typical polymer reinforced Portland cement now available has a strength of between 2400 and 5,500 psi to fracture. Therefore it is clear that the properties of the Portland cement, formed using the polymer additive of the invention, are extremely desirable. A typical prior polymer reinforced cement of the prior art is PVA (Polyvinyl Acetate) mfg by “Quickcrete”.

Below is Table 1 comparing properties of Portland Cement of the invention with ordinary Portland II Cement, a typical prior art polymer reinforced cement.

TABLE 1

| | | | Prior Polymer | | Invention | |
|---|---|---|---|---|---|---|
| | | | modified | | polymer rein- | |
| | Cement | | cement | | forced cement | |
| Flexural Strength | 600-800 | psi | 1400-1600 | psi | 1800-2100 | psi |
| Tensile Strength | 200-500 | psi | 300-500 | psi | 300-400 | psi |
| Compression | 2000-5500 | psi | ~5500 | psi | >8500 | psi |
| Strength | | | | | | |
| Flexural Strength | 600-1000 | psi | 1500 | psi | ~2100 | |
| Shear Strength | 50 | psi | — | | 600-700 | psi |
| values (28-day cure | | | | | | |
| cohesive failure) | | | | | | |

Note that wet, cured cement always has higher strength than dry, cured cement.

The compressive strength is determined by the ASTM C 109-73 test. The tensile strength is determined by the ASTM C 190-72 test. The flexural strength is determined by the ASTM C 348-72 test. The shear strength test is done by ASTM C 944-99 ASTM 4541-02 to determine the shear (adhesion) strength.

The amount of cement, aggregate, cement polymer additive of the invention, and water will be varied depending on the use intended for the cement and method of applying the cement. The cement suitable for use in gunning in a mine may, in a preferred form, have a composition, in parts by weight of about 1 part water, 4 parts invention polymer additive, 9 parts Type II Portland Cement, and 15 parts aggregate. A composition for use in a bridge support may, in a preferred form, comprise in parts by weight about 1 part water, 3 parts polymer additive composition of the invention, 8 parts Portland cement (Type II), and 8 parts aggregate. The weight ratio of Portland cement to the additive of the invention generally is between 9:4 and 3:1. Generally, a preferred amount is between 4 and 5 parts by weight cement to 1 part by weight of the additive of the invention for the formation of a strong and waterproof cement without utilizing a great amount of the more expensive additive.

### Example 1

An acrylic monomer Rohm & Haas “Roplex 1834” acrylic polymer (Rohm & Haas) is free of ammoniated additives and, therefore, is suitable for use with Portland Cement, is mixed in an amount of 3 kilograms, and 1 kilogram, an acrylic copolymer of acrylate of about 200 weight average molecular weight, and vinyl acrylic-vinyl copolymer (Rovace 661) are mixed and blended together in a steel vessel for a period of 30 minutes to one hour. Rovace 661 is a copolymer of acrylic polymer comprising polybutyl acetate and vinyl polymer comprising vinyl acrylic. The ratio of polymer and water in Rovace 661 is 55% polymers and 45% water. About 2.5 kilogram propylene glycol, 2 kilogram wetting agent having a composition of 9N9 triton (ethylene oxide condensate), and a 2 kilogram of a silicone fluid with a viscosity of about 40 cps are blended together in a separate vessel for a period of 30 minutes. The wetting agent is Triton X 100 or Dowfax 9N9 polymer. Both materials are ethylene oxide condensates. Triton X 100 is an alkylaryl polyether alcohol wetting agent of the non ionic classification. The propylene glycol, wetting agent and the silicone fluid blend is then introduced to the acryilic monomer/copolymer and the entire solution is blended for 30 minutes to form the polymer additive solution.

The blending of cement, aggregate, water, and the invention polymer additive in the above order will produce a finished cement slurry that can be used for placement as an insitu repair for concrete that is damaged due to wear and exposure to the elements. It could also be used as a gunning concrete mix.

The preferred mix ratio, by weight, is as follows:

1 part water; 4 parts polymer additive mixture; 9 parts cement; and 15 parts of cement-sand. Mix thoroughly for up to 30 minutes prior to use. This mixture is applied to repair an existing Portland Cement concrete sidewalk. The sidewalk is found to withstand ordinary traffic and treatment.

The modified concrete provides greater compressive, flexural, tensile, and bonding strength than Portland Cement. Test results show the ASTM standard test: compressive=8,000 psi; tensile=615 psi; flexural=1900 psi; and shear bond=650 psi. The compressive strength is determined by ASTM C 109-73 test. The tensile strength is determined by the ASTM C 190-72 test. The flexural strength is determined by ASTM C 348-72. The shear bond is after a 28-day cure and has a cohesive failure between 600-700 psi.

### Example 2 (Comparison Example)

About 10 kilograms of vinyl/acrylic copolymer binder as in Example 1 is blended with 2 kilograms Triton X 100 that has been diluted with equal parts by weight of propylene glycol and modified with 2 kilograms silicone fluid, that has a viscosity of 50 cps and is blended in a polyethylene container for 30 minutes. The product is then ready to be used in a Portland Cement mix design.

Blended ratios by weight are: vinyl/acrylic copolymer 8-parts by volume, blended with 2-parts of the mixture of Triton X 100, propylene glycol, and the silicone fluid.

This prior art polymer blend is used at a ratio of 10 lbs. per bag (94 pounds) of Portland Cement to make a concrete that has good bonding strength but has less strength than the composition of Example 1 above.

1. A polymer additive for Portland cement comprising acrylic monomer and copolymer, wetting agent, propylene glycol and silicone.

2. The additive of claim 1 wherein the acrylic monomer has molecular weight of between 79 and 200 as determined by weight average method.

3. The additive of claim 1 wherein said copolymer comprises copolymers of acrylic and vinyl acetyl.

4. The additive of claim 1 wherein the acrylic copolymer comprise at least one member selected from the group consisting of vinyl acrylic, butyl ethylene and propylene.

5. The additive of claim 1 wherein the wetting agent comprises a phenolic ethylene oxide condensate.

6. The additive of claim 1 wherein the wetting agent comprises n-octyl-phenolic ethylene oxide condensates blended with silicone fluid.

7. The additive of claim 1 wherein the wetting agent is emulsified with the propylene glycol.

8. The additive of claim 1 wherein the acrylic polymers and copolymers comprise between 75 and 90 weight percent of the additive for Portland cement.

9. The additive of claim 1 wherein the silicone fluid comprises between 1 and 3 weight percent of said additive for Portland cement.

10. The additive of claim 1 wherein the propylene glycol comprises between 5 and 15 weight percent of said additive.

11. A method of forming a strengthened Portland cement comprising 6 to 20 parts by weight Portland cement with between 1 to 3 parts by weight of an additive for Portland cement comprising acrylic monomers and copolymers, wetting agent, propylene glycol and silicone, 15 to 20 parts by weight and water as needed.

12. The method of claim 11 wherein the Portland cement is Type I or Type II Portland cement.

13. The method of claim 11 wherein the acrylic monomers have molecular weight of between 79 and 200 as determined by weight average method.

14. The method of claim 11 wherein said copolymers comprises copolymers of acrylic polymer/vinyl acrylic copolymer emulsion.

15. The method of claim 11 wherein the acrylic copolymers comprise at least one member selected from the group consisting vinyl, ethylene, and propylene.

16. The method of claim 11 wherein the wetting agent comprises a phenolic ethylene oxide condensate.

17. The method of claim 11 wherein the wetting agent comprises n-octyl-phenolic ethylene oxide condensate is blended with silicone fluid.

18. The method of claim 11 wherein the wetting agent is emulsified with the propylene glycol.

19. The method of claim 11 wherein the acrylic polymers and copolymers comprise between 75 and 90 weight percent of the additive.

20. The method of claim 11 wherein the silicone fluid comprises between 1 and 3 weight percent of the cement additive.

21. The method of claim 11 wherein the polypropylene glycol comprises between 5 and 15 weight percent of the cement additive.

22. A cement composition comprising Portland cement and a strengthening additive for Portland cement comprising acrylic monomers and copolymers, wetting agent, propylene glycol and silicone.

23. The composition of claim 22 wherein said composition has a flexural strength in the range of 1400-1800 psi.

24. The composition of claim 22 wherein the composition has a compressive strength of greater than 5000 psi.

25. The composition of claim 22 wherein said composition has a tensile strength of greater than 500 psi.
